(19) United States
(12) Patent Application Publication
(10) Pub. No.: US 2008/0238071 A1
(43) Pub. Date: Oct. 2, 2008

(54) Steering column of vehicle having collision energy absorbing apparatus

(75) Inventor: Jae Moon Oh, Gongju-si (KR)

Correspondence Address: HARNESS, DICKEY & PIERCE, P.L.C., P.O. BOX 828, BLOOMFIELD HILLS, MI, 48303, US

(73) Assignee: Mando Corporation

(21) Appl. No.: 12/079,625

(22) Filed: Mar. 27, 2008

(30) Foreign Application Priority Data
Mar. 30, 2007 (KR) 2007-0031677

(51) Int. Cl. B62D 1/11

(52) U.S. Cl. 280/777

(57) ABSTRACT

Disclosed is a steering column of a vehicle having a collision energy absorbing apparatus. The steering column includes: a hollow tube having a steering shaft disposed in the hollow tube; a plate bracket surrounding an outer peripheral surface of the tube and having guide grooves formed on a top part of the plate bracket; a reinforcing member for reinforcing and supporting the plate bracket, the reinforcing member being coupled to the tube and being provided within the plate bracket; and a mounting bracket having impact-absorbing guide members inserted in the guide grooves and fixing holes formed on both sides of the mounting bracket for fixing the mounting bracket to a chassis.

### CROSS-REFERENCE TO RELATED APPLICATION

This non-provisional application claims priority under 35 U.S.C §119(a) on Patent Application No. 10-2007-0031677 filed in Korea on Mar. 30, 2007, the entire contents of which are hereby incorporated by reference.

### BACKGROUND OF THE INVENTION

1. Field of the Invention

The present invention relates to a steering column of a vehicle having a collision energy absorbing apparatus, and more particularly to a steering column of a vehicle having a collision energy absorbing apparatus, which includes a bent member, a mounting bracket having impact-absorbing guide members formed on the lower part, and a plate bracket having guide grooves in which the impact-absorbing guide members are inserted and slide, wherein the bent member is fitted in one end of the mounting bracket, and is being pushed and unbent, so as to absorb impact by friction between the impact-absorbing guide members and the guide grooves when a vehicle crashes against an object, so that it is possible to absorb much impact, and it is thus unnecessary to produce a capsule and a tearing plate, which results in reduction of the production cost.

2. Description of the Prior Art

In general, a steering column refers to an apparatus, which encloses and supports a steering shaft that delivers rotatory force generated by a steering wheel operation of a driver to a rack-pinion mechanism, and is fixed to a chassis of a vehicle through a bracket, so as to fix a position of the steering shaft. When a vehicle crashes against an object, the upper part of the driver's body hits against the steering wheel and is injured. In order to prevent this, both the steering column and the steering shaft have a collapse function of being contracted in the shaft direction. That is, when a driver is involved in a crashing accident during the driving, the upper part of the driver's body hits against the steering wheel due to inertia. When the upper part of the driver's body hits against the steering wheel, the steering column and the steering shaft provided on the lower part of the steering wheel are contracted so as to reduce the impact applied to the driver.

However, the collision energy transferred to the steering wheel due to the collision between the steering wheel and the driver depends on a driver state and a vehicle state. For example, large collision energy is transferred when the vehicle is at high speed, while small collision energy is transferred when the vehicle is at a low speed. Further, the amount of collision energy applied to the steering wheel depends on several conditions such as the wearing of driver's seat belt, operation of an air bag, etc. A steering apparatus equipped with a tearing plate has been developed to cope with these various conditions.

FIG. 1 is a side view showing a collision energy absorbable steering column of a vehicle according to the prior art. As shown in the drawings, the collision energy absorbable steering column of the vehicle 100 according to the prior art includes a steering shaft 102, an inner tube 110, an outer tube 120, an upper bracket 130, and a tearing plate 170. The steering shaft 102 has an upper end connected to a steering wheel (not shown), and a lower end connected to a rack-pinion mechanism (not shown). The inner tube 110 protects the steering shaft 102, and the outer tube 120 has a diameter larger than that of the inner tube 110. The upper bracket 130 is coupled to a chassis through a capsule 140 while supporting an outer peripheral surface of the outer tube 120. The tearing plate 170 has one end fixed to the capsule 140 by a fixing means 150 and the other end fixed to the upper bracket 130 through a fixing member 160.

When the upper part of driver's body collides with the steering wheel due to a frontal impact of a vehicle, the steering column 100 is contracted in the direction (i.e. a collision energy transfer direction or a collapse direction) in which the impact has been applied to the steering wheel. Then, the upper bracket 130 together with the outer tube 120 is moved downwardly from the capsule 140 fixed to the chassis. That is, when the collision occurs, the upper bracket 130 is separated from the capsule 140, is easily released from the chassis, and then moves in the collision energy transfer direction, while the steering column 100 is contracted.

According to the contraction of the steering column, the upper bracket 130 moves against the capsule 140, and the upper bracket 130 moves downward. Then, force from the capsule 140 and force from the upper bracket 130 are applied to the tearing plate 170 in opposite directions. Therefore, the tearing plate 170 is torn along the movement of the upper bracket 130 while absorbing the collision energy.

However, as described above, in the prior art, in order to fix the capsule 140 and the tearing plate 170 to the upper bracket 130, it is necessary to precisely fabricate the parts of the upper bracket 130, to which the capsule 140 and the tearing plate 170 are fixed, respectively. Moreover, due to the capsule 140 and the tearing plate 170 having various shapes, the parts of the upper bracket 130, to which the capsule 140 and the tearing plate 170 are fixed, also have various shapes, which require a long time for fabrication of the parts.

Further, an additional manufacture of the capsule 140 and the tearing plate 170 may increase the manufacturing cost.

### SUMMARY OF THE INVENTION

Accordingly, the present invention has been made to solve the above-mentioned problems occurring in the prior art, and the present invention provides a steering column of a vehicle having a collision energy absorbing apparatus, which includes a bent member, a mounting bracket having impact-absorbing guide members formed on the lower part, and a plate bracket having guide grooves in which the impact-absorbing guide members are inserted and slide, wherein the bent member is fitted in one end of the mounting bracket, and is being pushed and unbent, so as to absorb impact by friction between the impact-absorbing guide members and the guide grooves when a vehicle crashes against an object, so that it is possible to absorb much impact, and it is thus unnecessary to produce a capsule and a tearing plate, which results in reduction of the production cost.

In accordance with another aspect of the present invention, there is provided a steering column of a vehicle having a collision energy absorbing apparatus, the steering column including: a hollow tube having a steering shaft disposed in the hollow tube; a plate bracket surrounding an outer peripheral surface of the tube and having guide grooves formed on a top part of the plate bracket; a reinforcing member for reinforcing and supporting the plate bracket, the reinforcing member being coupled to the tube and being provided within the plate bracket; and a mounting bracket having impact-absorbing guide members inserted in the guide grooves and fixing holes formed on both sides of the mounting bracket for fixing the mounting bracket to a chassis.

### BRIEF DESCRIPTION OF THE DRAWINGS

The above and other objects, features and advantages of the present invention will be more apparent from the following detailed description taken in conjunction with the accompanying drawings, in which:

FIG. 1 is a side view showing a collision energy absorbable steering column of a vehicle according to the prior art;

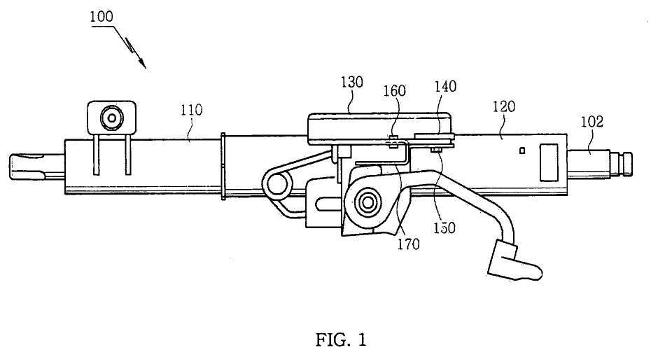

FIG. 2 is an exploded perspective view showing main elements of a steering column having a collision energy absorbing apparatus according to an exemplary embodiment of the present invention;

FIG. 3 is a perspective view of a steering column having a collision energy absorbing apparatus according to an exemplary embodiment of the present invention; and

FIGS. 4A and 4B are views showing an operation state of a steering column having a collision energy absorbing apparatus according to an exemplary embodiment of the present invention.

### DETAILED DESCRIPTION OF THE EXEMPLARY EMBODIMENTS

Hereinafter, an exemplary embodiment of the present invention will be described with reference to the accompanying drawings. In the following description and drawings, the same reference numerals are used to designate the same or similar components. Further, in the following description of the present invention, a detailed description of known functions and configurations incorporated herein will be omitted when it may make the subject matter of the present invention rather unclear.

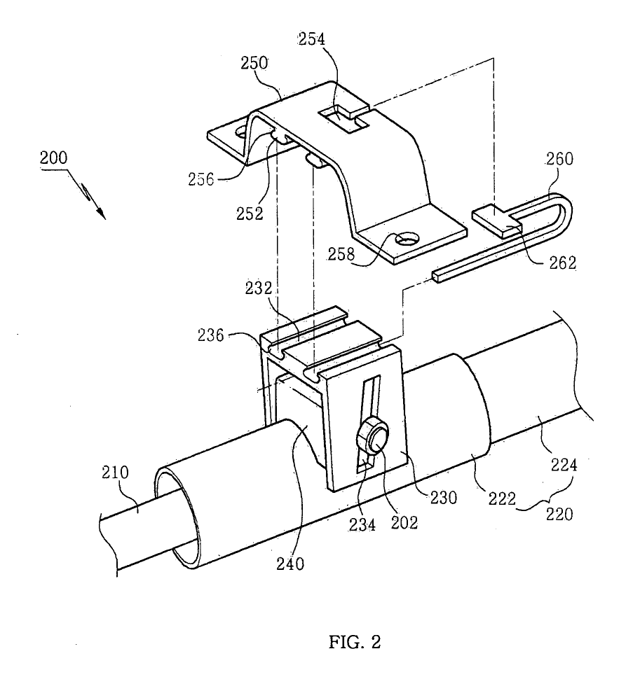

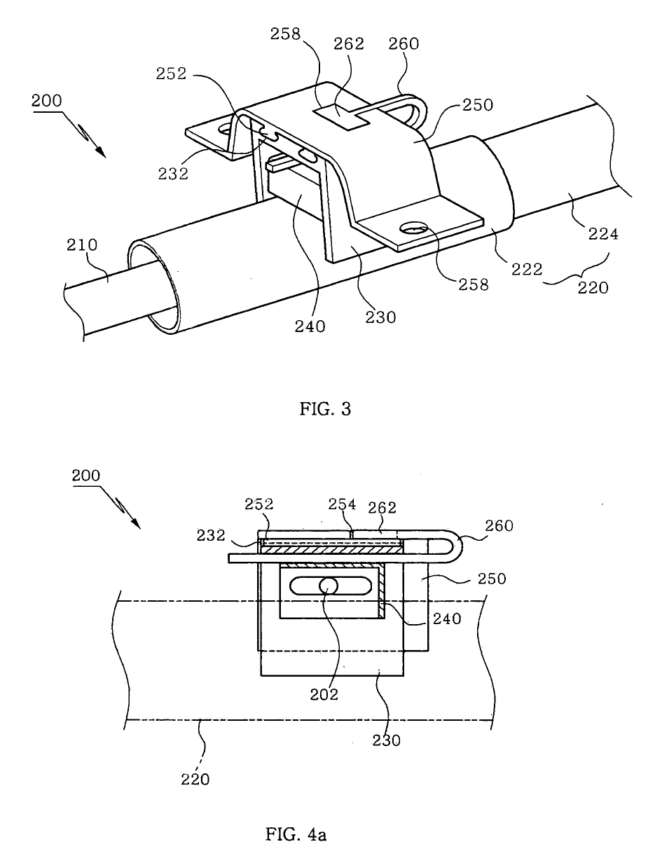

FIG. 2 is an exploded perspective view showing main elements of a steering column having a collision energy absorbing apparatus according to an exemplary embodiment of the present invention, and FIG. 3 is a perspective view of a steering column having a collision energy absorbing apparatus according to an exemplary embodiment of the present invention.

As shown in the drawings, the steering column 200 having the collision energy absorbing apparatus according to an exemplary embodiment of the present invention includes a tube 220, a plate bracket 230, a reinforcing member 240, a mounting bracket 250, and a bent member 260. The tube 220 houses a steering shaft 210 extending through the tube 220. The plate bracket 230 is fixed on both sides of an outer peripheral surface of the tube 220, and is provided with guide grooves 232 on a top part thereof. The guide grooves 232 extend in parallel to the steering shaft 210. The reinforcing member 240 is fixed on the top part of the tube 220, and supports an interior surface of the plate bracket 230. The mounting bracket 250 is fixed to a chassis, and has impact-absorbing guide members 252 inserted in the guide grooves 232 of the plate bracket 230, respectively. The bent member 260 has one end assembled with the mounting bracket 250, and is bent to absorb collision energy when a vehicle crashes against an object.

The tube 220 is a hollow tube in which a steering shaft 210 connected to a steering wheel (not shown) is fitted. Moreover, the tube 220 includes an outer tube 222 fixed to the chassis by means of the mounting bracket 250, and an inner tube 224 that has a diameter smaller than that of the outer tube 222, is inserted in the outer tube 222, and is fixed to the chassis by a bracket, such as a separate lower bracket (not shown).

The plate bracket 230 is bent to substantially have a shape of an inverted U, and both sides of the plate bracket 230 are fixed to the outer peripheral surface of the outer tube 222. The plate bracket 230 has an elongated hole 234 for the tilting operation, which is formed through one part of the plate bracket 230. The plate bracket 230 is assembled with the reinforcing member 240 by the fixing means 202 fitted in the elongated hole 234. Moreover, the plate bracket 230 is provided with guide grooves 232 formed on the top part thereof. The guide grooves 232 longitudinally extend in parallel to the steering shaft, and the impact-absorbing guide members 252 of the mounting bracket 250, which will be described later in more detail, are inserted in the guide grooves 232.

Herein, protuberance receiving seats 236 are formed at both sides of the lower part of each guide groove 232. Preferably, each of the protuberance receiving seats 236 extends lengthwise in parallel to the axial direction as does the guide groove 232. The protuberance receiving seat 236 may have various shapes, such as a circular shape, an oval shape, a hemispherical shape, and a polygonal shape according to the shape of an impact-absorbing guide protuberance 256 of the impact-absorbing guide member 252. The above-described protuberance receiving seat 236 increases the contact area between the guide groove 232 and the impact-absorbing guide member 252, thereby increasing the quantity of impact absorbed when a vehicle crashes against an object.

Further, a top surface of the bent member 260, which will be described later in more detail, is provided on the lower surface of an inside of the plate bracket 230.

The reinforcing member 240 refers to a bracket that is fixed to the top part of the tube 220 and is coupled to the tube 220 by welding, etc. The reinforcing member 240 supports the interior surface of the plate bracket 230 and reinforces the rigidity for the plate bracket 230. Moreover, the reinforcing member 240 has a through hole, through which the fixing means 202 extends to be assembled with the elongated hole 234 of the plate bracket 230.

Further, the bent member 260, which will be described later in more detail, is disposed on the top surface of the reinforcing member 240. That is, a lower surface of the inside of the plate bracket 230 and the top surface of the reinforcing member 240 guide the bent member 260 bent when a vehicle crashes against an object.

Herein, it is preferred that a typical fixing bolt is used as the fixing means 202, but the present invention is not to be limited by this.

The mounting bracket 250 is provided on the top part of the plate bracket 230 and is assembled with the plate bracket 230 so as to fix the outer tube 222 to the chassis. The mounting bracket 250 has the impact-absorbing guide members 252 protruding downward, which are provided on the lower part of the mounting bracket 250 and are inserted in the guide grooves 232 of the plate bracket 230. Moreover, a bent member holding hole 254 in which the bent member 260 is inserted and fitted is formed on one surface of the mounting bracket (i.e. the rear surface of the mounting bracket 250). The mounting bracket 250 has fixing holes 258 formed through both sides of the mounting bracket 250, so that the mounting bracket 250 is assembled with the chassis by a separate fixing member (not shown) fitted through the fixing hole 258. Herein, it is preferred that a typical fixing bolt is used as the fixing member.

Herein, it is preferred that the mounting bracket 250 and the plate bracket 230 are molded through extrusion, but the present invention is not to be limited by this.

Moreover, the impact-absorbing guide members 252 provided on the lower part of the mounting bracket 250 protrude downward, and are inserted in the guide grooves 232 of the plate bracket 230, so as to assemble the mounting bracket 250 and the plate bracket 230 with each other. Therefore, the impact-absorbing guide members 252 mainly serve as an assembling means for assembling the mounting bracket 250 with the plate bracket 230 and an impact absorption means for absorbing impact by friction that occurs while the impact-absorbing guide members 252 of the mounting bracket 250 are released from the guide grooves 232 of the plate bracket 230 when a vehicle crashes against an object.

The impact-absorbing guide member 252 is provided with the impact-absorbing guide protuberances 256 formed on both sides thereof, which are fitted in the protuberance receiving seats 236 of the guide groove 232.

The impact-absorbing guide protuberances 256 having various shapes, such as a circular shape, an oval shape, a hemispherical shape, and a polygonal shape increase the contact area between the guide groove 232 of the plate bracket 230 and the impact-absorbing guide member 252, thereby increasing both the coupling force of the mounting bracket 250 and the plate bracket 230 and the amount of impact absorbed by the guide groove 232 and the impact-absorbing guide member 252.

It is preferred that the impact-absorbing guide member 252 is forcedly inserted and fitted in the guide groove 232 of the plate bracket 230, but the scope of the invention is not to be limited to this method. That is, any method that can maintain the coupling force between the mounting bracket 250 and the plate bracket 230, and can absorbs impact through friction when a vehicle crashes against an object can be employed in assembling the mounting bracket 250 and the plate bracket 230.

It is preferred that a bent member holding hole 254 has a non-uniform size in order to tightly hold the bent member 260 to the mounting bracket 250. That is, a neck portion of the bent member holding hole 254 near to one end of the mounting bracket 250 has a width equal to the width of the trunk part of the bent member 260, while a central portion of the bent member holding hole 254 has a width is larger than the width of the neck portion of the bent member holding hole 254, so that a bent member holding head 262 can be inserted in the central portion of the bent member holding hole 254 and the trunk part of the bent member 260 can be inserted in the neck portion of the bent member holding hole 254. As a result, by simply inserting the bent member 260 in the bent member holding hole 254 without using any separate fixing member or any separate fixing method, it is possible to fixedly assemble the bent member 260 with the mounting bracket 250. Therefore, the present invention can reduce the manufacturing time and can improve the productivity.

Further, it is preferred that the bent member 260 has a non-uniform width as the bent member holding hole 254, and has a shape similar to the shape of the bent member holding hole 254. That is, as described above, the bent member 260 preferably has a bent member holding head 262 having a width larger than the width of the other portion of the bent member 260. Moreover, it is preferred that the bent member 260 is forcedly fitted in the mounting bracket 250, but the scope of the invention is not to be limited to the illustrated structure.

In the bent member 260 as described above, the bent member holding head 262 having a larger width than the other portion of the bent member 260 is formed at one end of the bent member 262 and is fitted in the central portion of the bent member holding hole 254. Then, the bent member 260 is bent in such a manner that the other end of the bent member 260 can be disposed between the plate bracket 230 and the reinforcing member 240. As a result, when a vehicle crashes against an object, the bent member 260 is unbent by the steering column 200 released from a chassis, thereby absorbing impact according to the degree to which the bent member 260 is unbent.

Hereinafter, a process of absorbing impact by the collision energy absorbing apparatus according to the present invention when a vehicle crashes against an object will be described.

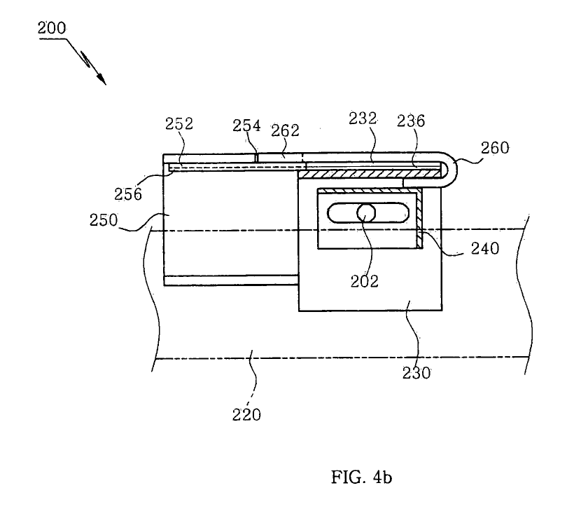

FIGS. 4A and 4B are views showing an operation state of a steering column having a collision energy absorbing apparatus according to an exemplary embodiment of the present invention.

As shown in the drawings, the steering column 200 having the collision energy absorbing apparatus according to an exemplary embodiment of the present invention includes the mounting bracket 250 fixed to a chassis. Therefore, when a vehicle crashes against an object, the plate bracket 230 moves along the impact-absorbing guide member 252 inserted in the guide groove 232 while causing friction between the impact-absorbing guide member 252 and the guide groove 232, which can absorb impact and reduce the damage applied to the driver.

Herein, since the plate bracket 230 is coupled to the tube 220, the tube 220 moves together with the plate bracket 230. In other words, the reinforcing member 240 is coupled to the tube 220 and the reinforcing member 240 is assembled with the plate bracket 230 through the fixing means 202. As a result, when the plate bracket 230 moves due to collision of the vehicle, the tube 220 also moves together with the plate bracket 230 while being collapsed.

Furthermore, the bent member 260 has one end assembled with the mounting bracket 250, a bent central portion, and the other end disposed between the plate bracket 230 and the reinforcing member 240. Therefore, when a vehicle crashes against an object, an end of the plate bracket 230 is released from the mounting bracket 250 and pushes the bent central portion of the bent member 260 while causing friction. Then, the bent portion of the bent member 260 is continuously unbent by the pushing end of the plate bracket 230, so that the bent member 260 can absorb impact as much as the amount by which the bent member 260 is unbent.

As described above, a steering column of a vehicle having a collision energy absorbing apparatus according to the present invention includes a bent member, a mounting bracket having impact-absorbing guide members formed on the lower part, and a plate bracket having guide grooves in which the impact-absorbing guide members are inserted and slide. In the steering column, the bent member is fitted in one end of the mounting bracket. When a vehicle crashes against an object, the bent member is being pushed and unbent, so as to absorb impact by friction between the impact-absorbing guide members and the guide grooves. Therefore, the present invention can absorb much more impact, and thus makes it unnecessary to produce a capsule and a tearing plate, which results in reduction of the production cost.

Although an exemplary embodiment of the present invention has been described for illustrative purposes, those skilled in the art will appreciate that various modifications, additions and substitutions are possible, without departing from the scope and spirit of the invention as disclosed in the accompanying claims. Accordingly, the embodiment disclosed in the present invention is not for limitation of a technical idea of the present invention, but is for description of the technical idea. The scope of all technical idea of the present invention is not to be limited by the above embodiment.

What is claimed is:

1. A steering column of a vehicle having a collision energy absorbing apparatus, the steering column comprising:
a hollow tube having a steering shaft disposed in the hollow tube;
a plate bracket surrounding an outer peripheral surface of the tube and having guide grooves formed on a top part of the plate bracket;
a reinforcing member for reinforcing and supporting the plate bracket, the reinforcing member being coupled to the tube and being provided within the plate bracket; and
a mounting bracket having impact-absorbing guide members inserted in the guide grooves and fixing holes formed on both sides of the mounting bracket for fixing the mounting bracket to a chassis.

2. The steering column as claimed in claim 1, further comprising a bent member having a first end fixed to the mounting bracket and a second end provided between the plate bracket and the reinforcing member, the bent member being unbent when a vehicle crashes against an object.

3. The steering column as claimed in claim 2, wherein the mounting bracket has a bent member holding hole for holding the bent member, the bent member has a bent member holding head formed at the first end of the bent member, and the bent member holding head is fitted in the bent member holding hole.

4. The steering column as claimed in claim 1, wherein the impact-absorbing guide member has impact-absorbing guide protuberances formed on both sides of the impact-absorbing guide member and the guide grooves has protuberance receiving seats formed inside, the impact-absorbing guide protuberances extending outward and being inserted in the guide grooves.

5. The steering column as claimed in claim 4, wherein each of the impact-absorbing guide protuberances and the protuberance receiving seats has one of a circular shape, an oval shape, a hemispherical shape, and a polygonal shape.
